(19) United States
(12) Patent Application Publication
(10) Pub. No.: US 2025/0287330 A1
(43) Pub. Date: Sep. 11, 2025

(54) DEVICES, METHODS, APPARATUSES, AND COMPUTER READABLE MEDIA FOR PROCESSING UPLINK TRANSMISSION FAILURE

(71) Applicant: Nokia Technologies Oy, Espoo (FI)

(72) Inventors: Ping YUAN, Beijing (CN); Frank FREDERIKSEN, Aalborg (DK)

(21) Appl. No.: 18/858,553

(22) PCT Filed: Apr. 25, 2022
(86) PCT No.: PCT/CN2022/088980

§ 371 Date: Oct. 21, 2024

(51) Int. Cl. H04W 56/00; H04W 72/1268; H04W 74/0833

(52) U.S. Cl. CPC H04W 56/0045; H04W 72/1268; H04W 74/0833

(57) ABSTRACT

Disclosed are devices, methods, apparatuses, and computer readable media for processing uplink transmission failure. An example terminal device may include at least one processor and at least one memory. The at least one memory may include computer program code, and the at least one memory and the computer program code may be configured to, with the at least one processor, cause the terminal device to perform: determining whether to transmit a message indicating an uplink transmission failure based on a condition relating to at least an uplink transmission time offset for scheduled uplink transmissions and a timing advance value for the scheduled uplink transmissions; and transmitting to a network device, the message, in a case where the condition is satisfied.

### TECHNICAL FIELD

Various example embodiments relate to devices, methods, apparatuses, and computer readable media for processing uplink (UL) transmission failure.

### BACKGROUND

In wireless communication system, network side may transmit downlink (DL) transmission to schedule a user equipment (UE) to perform a corresponding UL transmission. For example, the UE may receive from the network side a physical downlink control channel (PDCCH) in a slot labeled as e.g. slot n, which schedules the UE to perform a corresponding transmission of physical uplink shared channel (PUSCH) in a slot labeled as e.g. slot n+K2, which is the K2-th slot after the slot n. The K2 may also be expressed as K₂. For example, the UE may receive from the network side a physical downlink shared channel (PDSCH) in a slot labeled as e.g. slot n, and the UE may be scheduled to perform a physical uplink control channel (PUCCH) feedback transmission corresponding the PDSCH in a slot labeled as e.g. slot n+k, which is the k-th slot after the slot n. The k may indicate a number of slots for e.g. from receiving a PDSCH to transmitting a corresponding hybrid automatic repeat request (HARQ) feedback, and in this case the k may be indicted as a parameter PDSCH-to-HARQ_feedback. Alternatively, k may indicate a number of slots for e.g. from receiving a DL data to transmitting a corresponding UL acknowledgment (ACK), and in this case the k may be indicated as a parameter dl-DataToUL-ACK. A parameter labeled as K_offset, which may also be expressed as K_{offset}, is introduced. In this case, the UE may receive from the network side a PDCCH in a slot n to schedule the UE to transmit a corresponding PUSCH in a slot n+K2+K_offset, and the UE may receive from the network side a PDSCH in a slot n, and the UE may be scheduled to transmit a corresponding PUCCH corresponding to the PDSCH in a slot n+k+K_offset. In addition, the UE may start performing a corresponding UL transmission in advance with a timing advance (TA) value, which may be indicated as T_TA or T_{TA}, before the start of the corresponding DL slot.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may include computer program code, and the at least one memory and the computer program code may be configured to, with the at least one processor, cause the terminal device to perform: determining whether to transmit a message indicating an uplink transmission failure based on a condition relating to at least an uplink transmission time offset for scheduled uplink transmissions and a timing advance value for the scheduled uplink transmissions; and transmitting to a network device, the message, in a case where the condition is satisfied.

In some example embodiments, the uplink transmission time offset may be configured by the network device and may be between receiving a downlink transmission and performing a corresponding uplink transmission, and the timing advance value may be calculated by the terminal device.

In some example embodiments, the condition may be satisfied in a case where the uplink transmission time offset is less than the timing advance value.

In some example embodiments, the condition may be satisfied in a case where the uplink transmission time offset is less than the timing advance value plus a duration for processing a downlink transmission and preparing a corresponding uplink transmission.

In some example embodiments, the at least one memory and the computer program code may be further configured to, with the at least one processor, cause the terminal device to further perform: stopping the scheduled uplink transmissions, in a case where the condition is satisfied.

In some example embodiments, the at least one memory and the computer program code may be further configured to, with the at least one processor, cause the terminal device to further perform: transmitting, to the network device, a scheduling request as the message, in a case where the condition is satisfied.

In some example embodiments, the scheduling request may be transmitted based on a scheduling request configuration corresponding to the message.

In some example embodiments, the scheduling request configuration may be specific to the terminal device.

In some example embodiments, the scheduling request configuration may be shared by the terminal device and at least one other terminal device.

In some example embodiments, the at least one memory and the computer program code may be further configured to, with the at least one processor, cause the terminal device to further perform: initiating a random access procedure to transmit the message, in a case where the condition is satisfied.

In some example embodiments, the message may correspond to a preamble of the random access procedure, and a cell-radio network temporary identifier may be included in Message 3.

In some example embodiments, the message may correspond to a cause value associated with the uplink transmission failure, and the cause value and a cell-radio network temporary identifier may be included in Message 3.

In some example embodiments, the timing advance value may be included in the Message 3.

In a second aspect, disclosed is a network device. The network device may include at least one processor and at least one memory. The at least one memory may include computer program code, and the at least one memory and the computer program code may be configured to, with the at least one processor, cause the network device to perform: receiving, from a terminal device, a message indicating an uplink transmission failure associated with an uplink transmission time offset for scheduled uplink transmissions; and stopping scheduling the terminal device with the uplink transmission time offset for the scheduled uplink transmissions.

In some example embodiments, the at least one memory and the computer program code may be further configured to, with the at least one processor, cause the network device to further perform: configuring for the terminal device a scheduling request configuration corresponding to the message.

In some example embodiments, the at least one memory and the computer program code may be further configured to, with the at least one processor, cause the network device to further perform: instructing the terminal device to apply a maximum uplink transmission time offset of a cell the terminal device is associated with.

In some example embodiments, the at least one memory and the computer program code may be further configured to, with the at least one processor, cause the network device to further perform: instructing the terminal device to apply an uplink transmission time offset specific to a cell the terminal device is associated with.

In some example embodiments, the at least one memory and the computer program code may be further configured to, with the at least one processor, cause the network device to further perform: adjusting the uplink transmission time offset to be larger than a timing advance value for the scheduled uplink transmissions; and instructing the terminal device to apply the adjusted uplink transmission time offset.

In a third aspect, disclosed is a method performed by a terminal device. The method may comprise: determining whether to transmit a message indicating an uplink transmission failure based on a condition relating to at least an uplink transmission time offset for scheduled uplink transmissions and a timing advance value for the scheduled uplink transmissions; and transmitting to a network device, the message, in a case where the condition is satisfied.

In some example embodiments, the uplink transmission time offset may be configured by the network device and may be between receiving a downlink transmission and performing a corresponding uplink transmission, and the timing advance value may be calculated by the terminal device.

In some example embodiments, the condition may be satisfied in a case where the uplink transmission time offset is less than the timing advance value.

In some example embodiments, the condition may be satisfied in a case where the uplink transmission time offset is less than the timing advance value plus a duration for processing a downlink transmission and preparing a corresponding uplink transmission.

In some example embodiments, the method may further comprise: stopping the scheduled uplink transmissions, in a case where the condition is satisfied.

In some example embodiments, the method may further comprise: transmitting, to the network device, a scheduling request as the message, in a case where the condition is satisfied.

In some example embodiments, the scheduling request may be transmitted based on a scheduling request configuration corresponding to the message.

In some example embodiments, the scheduling request configuration may be specific to the terminal device.

In some example embodiments, the scheduling request configuration may be shared by the terminal device and at least one other terminal device.

In some example embodiments, the method may further comprise: initiating a random access procedure to transmit the message, in a case where the condition is satisfied.

In some example embodiments, the message may correspond to a preamble of the random access procedure, and a cell-radio network temporary identifier may be included in Message 3.

In some example embodiments, the message may correspond to a cause value associated with the uplink transmission failure, and the cause value and a cell-radio network temporary identifier may be included in Message 3.

In some example embodiments, the timing advance value may be included in the Message 3.

In a fourth aspect, disclosed is a method performed by a network device. The method may comprise: receiving, from a terminal device, a message indicating an uplink transmission failure associated with an uplink transmission time offset for scheduled uplink transmissions; and stopping scheduling the terminal device with the uplink transmission time offset for the scheduled uplink transmissions.

In some example embodiments, the method may further comprise: configuring for the terminal device a scheduling request configuration corresponding to the message.

In some example embodiments, the method may further comprise: instructing the terminal device to apply a maximum uplink transmission time offset of a cell the terminal device is associated with.

In some example embodiments, the method may further comprise: instructing the terminal device to apply an uplink transmission time offset specific to a cell the terminal device is associated with.

In some example embodiments, the method may further comprise: adjusting the uplink transmission time offset to be larger than a timing advance value for the scheduled uplink transmissions; and instructing the terminal device to apply the adjusted uplink transmission time offset.

In a fifth aspect, disclosed is an apparatus. The apparatus as a terminal device may comprise: means for determining whether to transmit a message indicating an uplink transmission failure based on a condition relating to at least an uplink transmission time offset for scheduled uplink transmissions and a timing advance value for the scheduled uplink transmissions; and means for transmitting to a network device, the message, in a case where the condition is satisfied.

In some example embodiments, the uplink transmission time offset may be configured by the network device and may be between receiving a downlink transmission and performing a corresponding uplink transmission, and the timing advance value may be calculated by the terminal device.

In some example embodiments, the condition may be satisfied in a case where the uplink transmission time offset is less than the timing advance value.

In some example embodiments, the condition may be satisfied in a case where the uplink transmission time offset is less than the timing advance value plus a duration for processing a downlink transmission and preparing a corresponding uplink transmission.

In some example embodiments, the apparatus may further comprise: means for stopping the scheduled uplink transmissions, in a case where the condition is satisfied.

In some example embodiments, the apparatus may further comprise: means for transmitting, to the network device, a scheduling request as the message, in a case where the condition is satisfied.

In some example embodiments, the scheduling request may be transmitted based on a scheduling request configuration corresponding to the message.

In some example embodiments, the scheduling request configuration may be specific to the terminal device.

In some example embodiments, the scheduling request configuration may be shared by the terminal device and at least one other terminal device.

In some example embodiments, the apparatus may further comprise: means for initiating a random access procedure to transmit the message, in a case where the condition is satisfied.

In some example embodiments, the message may correspond to a preamble of the random access procedure, and a cell-radio network temporary identifier may be included in Message 3.

In some example embodiments, the message may correspond to a cause value associated with the uplink transmission failure, and the cause value and a cell-radio network temporary identifier may be included in Message 3.

In some example embodiments, the timing advance value may be included in the Message 3.

In a sixth aspect, disclosed is an apparatus. The apparatus as a network device may comprise: means for receiving, from a terminal device, a message indicating an uplink transmission failure associated with an uplink transmission time offset for scheduled uplink transmissions; and means for stopping scheduling the terminal device with the uplink transmission time offset for the scheduled uplink transmissions.

In some example embodiments, the apparatus may further comprise: means for configuring for the terminal device a scheduling request configuration corresponding to the message.

In some example embodiments, the apparatus may further comprise: means for instructing the terminal device to apply a maximum uplink transmission time offset of a cell the terminal device is associated with.

In some example embodiments, the apparatus may further comprise: means for instructing the terminal device to apply an uplink transmission time offset specific to a cell the terminal device is associated with.

In some example embodiments, the apparatus may further comprise: means for adjusting the uplink transmission time offset to be larger than a timing advance value for the scheduled uplink transmissions; and means for instructing the terminal device to apply the adjusted uplink transmission time offset.

In a seventh aspect, a computer readable medium is disclosed. The computer readable medium may include instructions stored thereon for causing a terminal device to perform:

determining whether to transmit a message indicating an uplink transmission failure based on a condition relating to at least an uplink transmission time offset for scheduled uplink transmissions and a timing advance value for the scheduled uplink transmissions; and transmitting to a network device, the message, in a case where the condition is satisfied.

In some example embodiments, the uplink transmission time offset may be configured by the network device and may be between receiving a downlink transmission and performing a corresponding uplink transmission, and the timing advance value may be calculated by the terminal device.

In some example embodiments, the condition may be satisfied in a case where the uplink transmission time offset is less than the timing advance value.

In some example embodiments, the condition may be satisfied in a case where the uplink transmission time offset is less than the timing advance value plus a duration for processing a downlink transmission and preparing a corresponding uplink transmission.

In some example embodiments, the computer readable medium may further include instructions stored thereon for causing the terminal device to further perform: stopping the scheduled uplink transmissions, in a case where the condition is satisfied.

In some example embodiments, the computer readable medium may further include instructions stored thereon for causing the terminal device to further perform: transmitting, to the network device, a scheduling request as the message, in a case where the condition is satisfied.

In some example embodiments, the scheduling request may be transmitted based on a scheduling request configuration corresponding to the message.

In some example embodiments, the scheduling request configuration may be specific to the terminal device.

In some example embodiments, the scheduling request configuration may be shared by the terminal device and at least one other terminal device.

In some example embodiments, the computer readable medium may further include instructions stored thereon for causing the terminal device to further perform: initiating a random access procedure to transmit the message, in a case where the condition is satisfied.

In some example embodiments, the message may correspond to a preamble of the random access procedure, and a cell-radio network temporary identifier may be included in Message 3.

In some example embodiments, the message may correspond to a cause value associated with the uplink transmission failure, and the cause value and a cell-radio network temporary identifier may be included in Message 3.

In some example embodiments, the timing advance value may be included in the Message 3.

In an eighth aspect, a computer readable medium is disclosed. The computer readable medium may include instructions stored thereon for causing a network device to perform: receiving, from a terminal device, a message indicating an uplink transmission failure associated with an uplink transmission time offset for scheduled uplink transmissions; and stopping scheduling the terminal device with the uplink transmission time offset for the scheduled uplink transmissions.

In some example embodiments, the computer readable medium may further include instructions stored thereon for causing the network device to further perform: configuring for the terminal device a scheduling request configuration corresponding to the message.

In some example embodiments, the computer readable medium may further include instructions stored thereon for causing the network device to further perform: instructing the terminal device to apply a maximum uplink transmission time offset of a cell the terminal device is associated with.

In some example embodiments, the computer readable medium may further include instructions stored thereon for causing the network device to further perform: instructing the terminal device to apply an uplink transmission time offset specific to a cell the terminal device is associated with.

In some example embodiments, the computer readable medium may further include instructions stored thereon for causing the network device to further perform: adjusting the uplink transmission time offset to be larger than a timing advance value for the scheduled uplink transmissions; and instructing the terminal device to apply the adjusted uplink transmission time offset.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary scenario to which the example embodiments of the present disclosure may be implemented.

FIG. 2 shows an exemplary sequence diagram for processing UL transmission failure according to the example embodiments of the present disclosure.

FIG. 3 shows a flow chart illustrating an example method 300 for processing UL transmission failure according to the example embodiments of the present disclosure.

FIG. 4 shows a flow chart illustrating an example method 400 for processing UL transmission failure according to the example embodiments of the present disclosure.

FIG. 5 shows a block diagram illustrating an example device 500 for processing UL transmission failure according to the example embodiments of the present disclosure.

FIG. 6 shows a block diagram illustrating an example device 600 for processing UL transmission failure according to the example embodiments of the present disclosure.

FIG. 7 shows a block diagram illustrating an example apparatus 700 for processing UL transmission failure according to the example embodiments of the present disclosure.

FIG. 8 shows a block diagram illustrating an example apparatus 800 for processing UL transmission failure according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

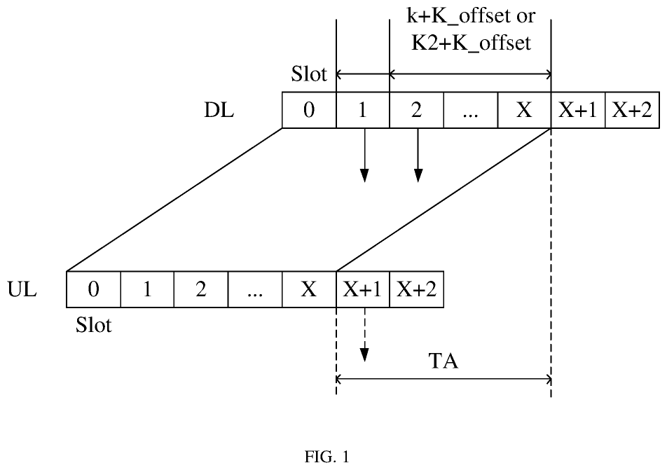

FIG. 1 shows an exemplary scenario to which the example embodiments of the present disclosure may be implemented. In the FIG. 1, a series of DL slots and a series of corresponding UL slots for a UE are diagrammatically depicted. Assuming slot 2 is an occasion for the UE to receiving a DL transmission, and the UE to perform a corresponding UL transmission at an occasion of slot X+1, in this case, k+K_offset or K2+K_offset is a number of slots from the slot 2 to slot X, and the slot X+1 is the (k+K_offset)-th or (K2+K_offset)-th slot after the slot 2. The UL slots start ahead of the corresponding DL slots by a TA.

Generally, if k+K_offset or K2+K_offset is larger than the TA, the UE can perform the UL transmission after receiving the corresponding DL transmission. For example, if the UE receives a DL transmission at DL slot 0, and the UE is scheduled to perform a corresponding UL transmission at slot X+1, in this case the k+K_offset or K2+K_offset is a number of slots from slot 0 to slot X and is larger than the TA, and thus the UE can perform the corresponding UL transmission at UL slot X+1 which is after the DL slot 0.

In a case where k+K_offset or K2+K_offset is less than the TA, the UE cannot perform the UL transmission before receiving the corresponding DL transmission. For example, if the UE receives a DL transmission at DL slot 2, and the UE is scheduled to perform a corresponding UL transmission at slot X+1, in this case the k+K_offset or K2+K_offset is a number of slots from slot 2 to slot X and is less than the TA, and thus the UE cannot perform the corresponding UL transmission at UL slot X+1 which is before the DL slot 2. So, an UL transmission failure may occur due to insufficient time left for the UL transmission.

Example embodiments of the present disclosure provide a solution for processing UL transmission failure caused by, for example, k+K_offset or K2+K_offset less than the TA.

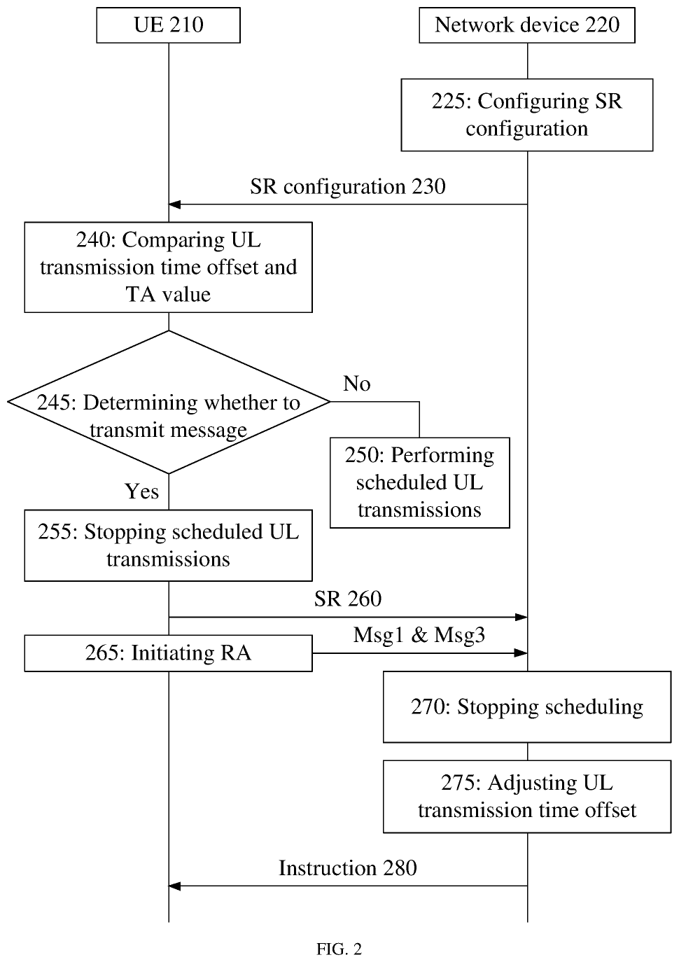

FIG. 2 shows an exemplary sequence diagram for processing UL transmission failure according to the example embodiments of the present disclosure. Referring to the FIG. 2, a UE 210 may represent any terminal device in a wireless communication network. A network device 220 may function as a base station (BS) in the wireless communication network and serving the UE 210. The UE 210 may have an arrangement of DL and UL slots shown in the FIG. 1.

In an operation 240, the UE 210 may compare a UL transmission time offset for scheduled UL transmissions with a TA value for the scheduled UL transmissions. The TA value may be calculated by the UE 210 through an approach e.g. described in 3rd Generation Partnership Project (3GPP) Specification 38.211, Section 4.3.1, in which the TA value may be indicated as TTA. The UL transmission time offset may be configured by the network device and may be an offset between receiving a DL transmission and performing a corresponding UL transmission. For example, in a case where the DL transmission to schedule a corresponding a PUSCH is via a PDCCH, the transmission time offset may be e.g. K₂+K_{offset} indicated in 3GPP Specification 38.214, Section 6.1.2.1. For example, in a case where the DL transmission is PDSCH and a corresponding UL transmission is a PUCCH, the transmission time offset may be e.g. k+K_{offset} indicated in 3GPP Specification 38.214, Section 9.2.3. The comparison in the operation 240 may be used for the UE 210 to detect whether a UL transmission failure will potentially occur.

In an operation 245, the UE 210 may determine whether to transmit a message indicating a UL transmission failure based on a condition relating to at least the UL transmission time offset and the TA value. If the condition is not satisfied, the UE 210 may detect that the UL transmission failure does not occur (“No” prong of the operation 245), and in an operation 250 the UE 210 may perform the scheduled UL transmissions. If the condition is satisfied, the UE 210 may detect the potential event of UL transmission failure and determine to transmit a message indicating the UL transmission failure (“Yes” prong of the operation 245).

In an embodiment, the condition may be satisfied in a case where the UL transmission time offset is less than the TA value. This may be the scenario of k+K_offset or K2+K_offset less than TA which has been described with respect to the FIG. 1, in which the UE 210 may detect having lost the possibility for being able to perform corresponding UL transmissions in due time.

Alternatively, in an embodiment, an additional period for processing delay and/or margin of UE 210 may be taken into account for the comparison. For example, the condition may be satisfied in a case where the UL transmission time offset is less than the TA value plus a duration for processing the DL transmission and preparing the corresponding UL transmission. Referring to the FIG. 1, for example, if the UE receives a DL transmission at DL slot 1, and the UE is scheduled to perform a corresponding UL transmission at slot X+1, in this case the k+K_offset or K2+K_offset is a number of slots from slot 1 to slot X. Although in this case the k+K_offset or K2+K_offset is not less than the TA, probably there is no sufficient time left for the UE 210 to process the DL transmission and prepare the corresponding UL transmission so as to complete the corresponding UL transmission at UL slot X+1. So, the UL transmission failure may potentially occur.

Referring back to the FIG. 2, in this embodiment, in the operation 240, the UE 210 may compare the UL transmission time offset with the TA value plus the duration for processing the DL transmission and preparing the corresponding UL transmission. If the UL transmission time offset is less than the TA value plus the duration, the condition is satisfied, and the UE 210 may determine to transmit a message indicating the UL transmission failure (“Yes” prong of the operation 245).

Before or after the transmission of the message, or meanwhile, in an operation 255, the UE 210 may stop the scheduled uplink transmissions, such that the waste of UL resources and interference to other UEs may be avoided. To avoid continuous UL scheduling failure, the UE 210 may transmit to the network device 220, the message for indicating that the scheduled UL transmission is blocked by the UE 210 itself.

The message may be transmitted by means of a scheduling request (SR) or a random access (RA) procedure. In an embodiment, the UE 210 may transmit, to the network device 220, a SR 260 as the message indicating the UL transmission failure due to insufficient time for the UL transmission. Because the SR 260 is not scheduled by the network side, the transmission of the SR 260 is not impacted by the UL transmission time offset.

In an embodiment, in an operation 225, the network device 220 may configure for the UE 210 a SR configuration 230 corresponding to the message. The SR configuration 230 may be opportunity and/or resource for transmitting the SR 260 and may explicitly corresponding to the potential event of UL transmission failure due to insufficient time for the UL transmission. The network device 220 may indicate the explicit SR configuration 230 for the UL transmission failure to the UE 210 via a radio resource control (RRC) signaling. Alternatively or additionally, the SR configuration 230 may be pre-specified in e.g. a 3GPP specification or standard. Regardless of whether being configured by the network device 220 or pre-specified in the specification or standard, with the SR configuration 230 explicitly corresponding to the potential event of UL transmission failure, the SR 260 may be transmitted based on the SR configuration 230 corresponding to the message.

As an option, the SR configuration 230 may be specific to the UE 210. Alternatively, the SR configuration 230 may be shared by the UE 210 and at least one other UE for the identical usage.

Alternatively, in an embodiment, in an operation 265, the UE 210 may initiate a RA procedure to transmit the message indicating the UL transmission failure due to insufficient time for the UL transmission. The RA procedure may be a contention free random access (CFRA) or a contention based random access (CBRA). The RA procedure may be initiated when the UE 210 is in RRC connected mode. Alternatively, the RA procedure may be initiated when the UE 210 is in RRC inactive mode or idle mode.

In an embodiment, the message may correspond to a preamble of the RA, and a cell-radio network temporary identifier (C-RNTI) may be included in Message 3 (Msg3). For example, a preamble in Message 1 (Msg1) may be allocated for the message, and if this preamble is included in the Msg1, the network device 220 may be aware that the UL transmission failure due to insufficient time for the UL transmission occurs. With the C-RNTI in the Msg3, the network device 220 may be aware that the message is from the UE 210.

Alternatively, the message may correspond to a cause value associated with the UL transmission failure, and the cause value and the C-RNTI are included in Message 3. For example, a cause value may indicate that the UL transmission failure due to insufficient time for the UL transmission occurs. With the cause value and the C-RNTI in the Msg3, the network device 220 may be aware that the UL transmission failure occurs in the UE 210.

Receiving the message via the SR 260 or the RA procedure, the network device 220 may instruct the UE 210 to apply a different UL transmission time offset so as to avoid the UL transmission failure.

Before or after the transmission of the instruction, or meanwhile, in an operation 270, the network device 220 may stop scheduling the UE 210 with the current uplink transmission time offset, such that the continuous UL scheduling which will cause UL transmission failure and waste the UL resource in vain may be avoided.

For avoiding the UL transmission failure, in an embodiment, the network device 220 may instruct the UE 210, via an instruction 280, to apply a maximum UL transmission time offset of a cell the UE 210 is associated with. The maximum UL transmission time offset of the cell may be e.g. the k or K2 plus the maximum K_offset of the cell, which may be larger than the TA value of the UE 210, such that the network device 220 may recover the UL scheduling and the UE 210 may recover the scheduled UL transmissions with the maximum UL transmission time offset of the cell.

Alternatively, in an embodiment, the network device 220 may instruct the UE 210, via the instruction 280, to apply a UL transmission time offset specific to the cell the UE 210 is associated with. The UL transmission time offset specific to the cell may be the k or K2 plus a K_offset specific to the cell, which may be larger than the TA value of the UE 210, such that the network device 220 may recover the UL scheduling and the UE 210 may recover the scheduled UL transmissions with the UL transmission time offset specific to the cell.

Alternatively, in a case where the network device 220 may be aware the TA value of the UE 210, for example, via the message or Msg3, in an operation 275, the network device 220 may adjust the UL transmission time offset to be larger than the TA value for the scheduled UL transmissions. For example, the network device 220 may adjust the K_offset specific to the UE 210 to a new value such that the k or K2 plus the new value of the K_offset may be larger than the TA value of the UE 210. Then, the network device 220 may instruct the UE 210, via the instruction 280, to apply the adjusted UL transmission time offset, which may be larger than the TA value of the UE 210, such that the network device 220 may recover the UL scheduling and the UE 210 may recover the scheduled UL transmissions with the adjusted UL transmission time offset.

The example embodiments of the present disclosure can handle the abnormal cases of for example the PUSCH and/or PUCCH HARQ-ACK transmission failure caused by the UL transmission time offset, e.g. K_offset+K2 or K_offset+k, which is less than the TA value. According to the example embodiments, the scheduled UL transmissions can be blocked by the UE due to insufficient time for UL transmission, and thus the waste of UL resources may be avoided. Further, in the example embodiments, the scheduled UL transmissions may be promptly recovered after the SR or RA procedure.

The example embodiments of the present disclosure can apply in various wireless communication networks such as a new radio (NR) non-terrestrial network (NTN), internet of things (IoT) NTN.

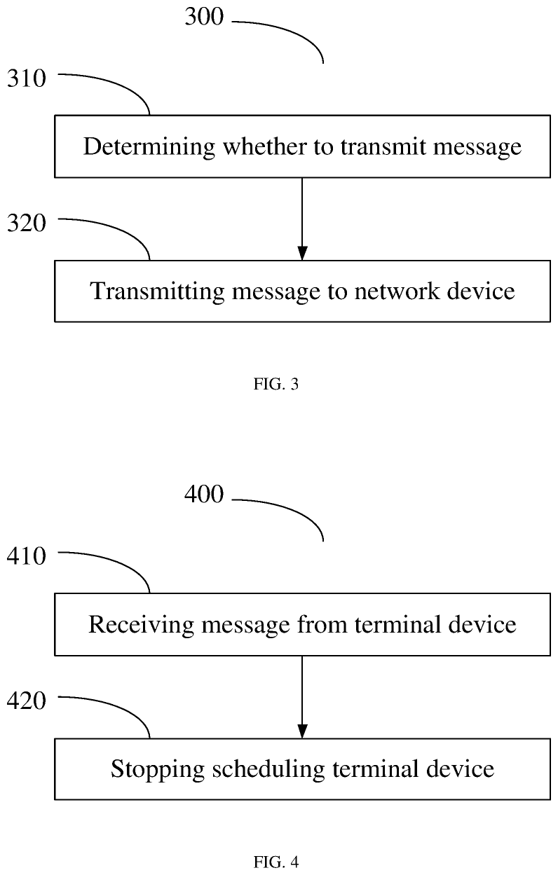

FIG. 3 shows a flow chart illustrating an example method 300 for processing UL transmission failure according to the example embodiments of the present disclosure. The example method 300 may be performed for example at a terminal device such as the UE 210.

Referring to the FIG. 3, the example method 300 may include an operation 310 of determining whether to transmit a message indicating a UL transmission failure based on a condition relating to at least a UL transmission time offset for scheduled UL transmissions and a TA value for the scheduled UL transmissions; and an operation 320 of transmitting to a network device, the message, in a case where the condition is satisfied.

Details of the operation 310 have been described in the above descriptions with respect to at least the operation 240 and the operation 245, and repetitive descriptions thereof are omitted here.

Details of the operation 220 have been described in the above descriptions with respect to at least the SR 260 and the operation 265, and repetitive descriptions thereof are omitted here.

In an embodiment, the UL transmission time offset may be configured by the network device and may be between receiving a DL transmission and performing a corresponding UL transmission, and the TA value may be calculated by the terminal device. The more details have been described in the above descriptions with respect to at least the operation 240, and repetitive descriptions thereof are omitted here.

In an embodiment, the condition may be satisfied in a case where the UL transmission time offset is less than the TA value. The more details have been described in the above descriptions with respect to at least the FIG. 1 and the operation 240, and repetitive descriptions thereof are omitted here.

In an embodiment, the condition may be satisfied in a case where the UL transmission time offset is less than the TA value plus a duration for processing a DL transmission and preparing a corresponding UL transmission. The more details have been described in the above descriptions with respect to at least the FIG. 1 and the operation 240, and repetitive descriptions thereof are omitted here.

In an embodiment, the example method 300 may further include an operation of stopping the scheduled UL transmissions, in a case where the condition is satisfied. The more details have been described in the above descriptions with respect to at least the operation 255, and repetitive descriptions thereof are omitted here.

In an embodiment, the example method 300 may further include an operation of transmitting, to the network device, a SR as the message, in a case where the condition is satisfied. The more details have been described in the above descriptions with respect to at least the SR 260, and repetitive descriptions thereof are omitted here.

In an embodiment, the SR may be transmitted based on a SR configuration corresponding to the message. The more details have been described in the above descriptions with respect to at least the operation 225, the SR configuration 230 and the SR 260, and repetitive descriptions thereof are omitted here.

In an embodiment, the SR configuration may be specific to the terminal device. The more details have been described in the above descriptions with respect to at least the SR configuration 230, and repetitive descriptions thereof are omitted here.

In an embodiment, the SR configuration may be shared by the terminal device and at least one other terminal device. The more details have been described in the above descriptions with respect to at least the SR configuration 230, and repetitive descriptions thereof are omitted here.

In an embodiment, the example method 300 may further include an operation of initiating a RA procedure to transmit the message, in a case where the condition is satisfied. The more details have been described in the above descriptions with respect to at least the operation 265, and repetitive descriptions thereof are omitted here.

In an embodiment, the message may correspond to a preamble of the RA procedure, and a C-RNTI may be included in Msg3. The more details have been described in the above descriptions with respect to at least the operation 265, the Msg1 and the Msg3, and repetitive descriptions thereof are omitted here.

In an embodiment, the message may correspond to a cause value associated with the UL transmission failure, and the cause value and a C-RNTI may be included in Msg3. The more details have been described in the above descriptions with respect to at least the operation 265 and the Msg3, and repetitive descriptions thereof are omitted here.

In an embodiment, the TA value may be included in the Msg3. The more details have been described in the above descriptions with respect to at least the Msg3 and the operation 275, and repetitive descriptions thereof are omitted here.

FIG. 4 shows a flow chart illustrating an example method 400 for processing UL transmission failure according to the example embodiments of the present disclosure. The example method 400 may be performed for example at a network device such as the network device 220.

Referring to the FIG. 4, the example method 400 may include an operation 410 of receiving, from a terminal device, a message indicating a UL transmission failure associated with a UL transmission time offset for scheduled UL transmissions; and an operation 420 of stopping scheduling the terminal device with the UL transmission time offset for the scheduled UL transmissions.

Details of the operation 410 have been described in the above descriptions with respect to at least the SR 260 and the operation 265, and repetitive descriptions thereof are omitted here.

Details of the operation 420 have been described in the above descriptions with respect to at least the operation 270, and repetitive descriptions thereof are omitted here.

In an embodiment, the example method 400 may further include an operation of configuring for the terminal device a SR configuration corresponding to the message. The more details have been described in the above descriptions with respect to at least the operation 225 and the SR configuration 230, and repetitive descriptions thereof are omitted here.

In an embodiment, the example method 400 may further include an operation of instructing the terminal device to apply a maximum UL transmission time offset of a cell the terminal device is associated with. The more details have been described in the above descriptions with respect to at least the instruction 280, and repetitive descriptions thereof are omitted here.

In an embodiment, the example method 400 may further include an operation of instructing the terminal device to apply a UL transmission time offset specific to a cell the terminal device is associated with. The more details have been described in the above descriptions with respect to at least the instruction 280, and repetitive descriptions thereof are omitted here.

In an embodiment, the example method 400 may further include an operation of adjusting the UL transmission time offset to be larger than a TA value for the scheduled UL transmissions; and an operation of instructing the terminal device to apply the adjusted UL transmission time offset. The more details have been described in the above descriptions with respect to at least the operation 275 and the instruction 280, and repetitive descriptions thereof are omitted here.

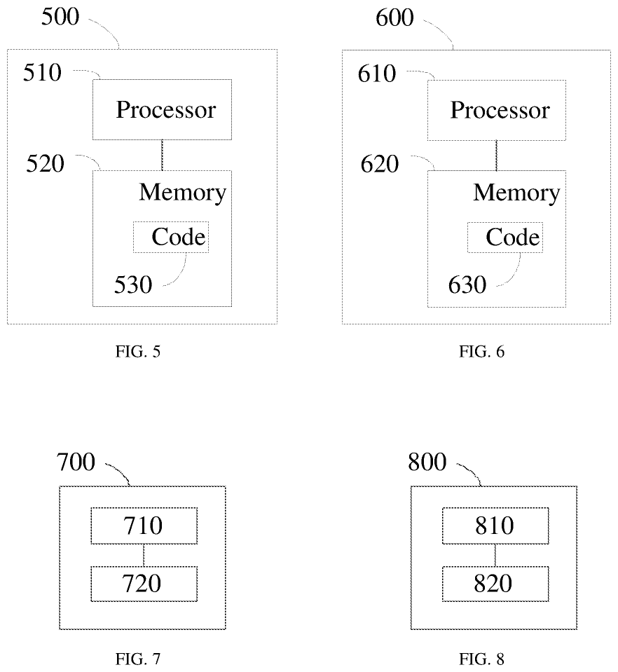

FIG. 5 shows a block diagram illustrating an example device 500 for processing UL transmission failure according to the example embodiments of the present disclosure. The device, for example, may be at least part of a terminal device such as the UE 210 in the above examples.

As shown in the FIG. 5, the example device 500 may include at least one processor 510 and at least one memory 520 that may include computer program code 530. The at least one memory 520 and the computer program code 530 may be configured to, with the at least one processor 510, cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or clement not shown in the FIG. 5.

In various example embodiments, the at least one memory 520 in the example device 500 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 210 is not limited to the above example device 500.

FIG. 6 shows a block diagram illustrating an example device 600 for processing UL transmission failure according to the example embodiments of the present disclosure. The device, for example, may be at least part of a network device such as the network device 220 in the above examples.

As shown in the FIG. 6, the example device 600 may include at least one processor 610 and at least one memory 620 that may include computer program code 630. The at least one memory 620 and the computer program code 630 may be configured to, with the at least one processor 610, cause the device 600 at least to perform the example method 400 described above.

In various example embodiments, the at least one processor 610 in the example device 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 610 may also include at least one other circuitry or element not shown in the FIG. 6.

In various example embodiments, the at least one memory 620 in the example device 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 620 may include, but are not limited to, an electric, a magnetic, an optical, an electromagnetic, an infrared, or a semiconductor system, apparatus, or device or any combination of the above.

Further, in various example embodiments, the example device 600 may also include at least one other circuitry, element, and interface, for example at least one I/O interface, at least one antenna element, and the like.

In various example embodiments, the circuitries, parts, elements, and interfaces in the example device 600, including the at least one processor 610 and the at least one memory 620, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 220 is not limited to the above example device 600.

FIG. 7 shows a block diagram illustrating an example apparatus 700 for processing UL transmission failure according to the example embodiments of the present disclosure. The apparatus, for example, may be at least part of a terminal device such as the UE 210 in the above examples.

As shown in FIG. 7, the example apparatus 700 may include means 710 for performing the operation 310 of the example method 300, and means 720 for performing the operation 320 of the example method 300. In one or more another example embodiments, at least one I/O interface, at least one antenna element, and the like may also be included in the example apparatus 700.

In some example embodiments, examples of means in the example apparatus 700 may include circuitries. For example, an example of means 710 may include a circuitry configured to perform the operation 310 of the example method 300, and an example of means 720 may include a circuitry configured to perform the operation 320 of the example method 300. In some example embodiments, examples of means may also include software modules and any other suitable function entities.

FIG. 8 shows a block diagram illustrating an example apparatus 800 for processing UL transmission failure according to the example embodiments of the present disclosure. The apparatus, for example, may be at least part of a network device such as the network device 220 in the above examples.

As shown in FIG. 8, the example apparatus 800 may include means 810 for performing the operation 410 of the example method 400, and means 820 for performing the operation 420 of the example method 400. In one or more another example embodiments, at least one I/O interface, at least one antenna element, and the like may also be included in the example apparatus 800.

In some example embodiments, examples of means in the example apparatus 800 may include circuitries. For example, an example of means 810 may include a circuitry configured to perform the operation 410 of the example method 400, and an example of means 820 may include a circuitry configured to perform the operation 420 of the example method 400. In some example embodiments, examples of means may also include software modules and any other suitable function entities.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP 3rd Generation Partnership Project
ACK acknowledgment
BS base station
CBRA contention based random access
CFRA contention free random access
C-RNTI cell-radio network temporary identifier
DL downlink
HARQ hybrid automatic repeat request
IoT internet of things
Msg1 Message 1
Msg3 Message 3
NR new radio
NTN non-terrestrial network
PDCCH physical downlink control channel
PDSCH physical downlink shared channel
PUCCH physical uplink control channel
PUSCH physical uplink shared channel
RA random access
RRC radio resource control
SR scheduling request
TA timing advance
UE user equipment
UL uplink

1. A terminal device, comprising:
at least one processor; and
at least one memory comprising computer program code, the at least one memory and the computer program code being configured to, with the at least one processor, cause the terminal device to perform:
determining whether to transmit a message indicating an uplink transmission failure based on a condition relating to at least an uplink transmission time offset for scheduled uplink transmissions and a timing advance value for the scheduled uplink transmissions; and
transmitting to a network device, the message, in a case where the condition is satisfied.

2. The terminal device of claim 1, wherein the uplink transmission time offset is configured by the network device and is between receiving a downlink transmission and performing a corresponding uplink transmission, and the timing advance value is calculated by the terminal device.

3. The terminal device of claim 1, wherein the condition is satisfied in a case where the uplink transmission time offset is less than the timing advance value.

4. The terminal device of claim 1, wherein the condition is satisfied in a case where the uplink transmission time offset is less than the timing advance value plus a duration for processing a downlink transmission and preparing a corresponding uplink transmission.

5. The terminal device of claim 1, wherein the at least one memory and the computer program code are further configured to, with the at least one processor, cause the terminal device to further perform:
stopping the scheduled uplink transmissions, in a case where the condition is satisfied.

6. The terminal device of claim 1, wherein the at least one memory and the computer program code are further configured to, with the at least one processor, cause the terminal device to further perform:
transmitting, to the network device, a scheduling request as the message, in a case where the condition is satisfied, wherein the scheduling request is transmitted based on a scheduling request configuration corresponding to the message.

7. (canceled)

8. The terminal device of claim 6, wherein the scheduling request configuration is specific to the terminal device.

9. The terminal device of claim 6, wherein the scheduling request configuration is shared by the terminal device and at least one other terminal device.

10. The terminal device of claim 1, wherein the at least one memory and the computer program code are further configured to, with the at least one processor, cause the terminal device to further perform:
initiating a random access procedure to transmit the message, in a case where the condition is satisfied.

11. The terminal device of claim 10, wherein the message corresponds to a preamble of the random access procedure, and a cell-radio network temporary identifier is included in Message 3.

12. The terminal device of claim 10, wherein the message corresponds to a cause value associated with the uplink transmission failure, and the cause value and a cell-radio network temporary identifier are included in Message 3.

13. The terminal device of claims 1, wherein the timing advance value is included in the Message 3.

14. A network device, comprising:
at least one processor; and
at least one memory comprising computer program code, the at least one memory and the computer program code being configured to, with the at least one processor, cause the network device to perform:
receiving, from a terminal device, a message indicating an uplink transmission failure associated with an uplink transmission time offset for scheduled uplink transmissions; and
stopping scheduling the terminal device with the uplink transmission time offset for the scheduled uplink transmissions.

15. The network device of claim 14, wherein the at least one memory and the computer program code are further configured to, with the at least one processor, cause the network device to further perform:
configuring for the terminal device a scheduling request configuration corresponding to the message.

16. The network device of claim 14, wherein the at least one memory and the computer program code are further configured to, with the at least one processor, cause the network device to further perform:
instructing the terminal device to apply a maximum uplink transmission time offset of a cell the terminal device is associated with.

17. The network device of claim 14, wherein the at least one memory and the computer program code are further configured to, with the at least one processor, cause the network device to further perform:
instructing the terminal device to apply an uplink transmission time offset specific to a cell the terminal device is associated with.

18. The network device of claim 14, wherein the at least one memory and the computer program code are further configured to, with the at least one processor, cause the network device to further perform:
adjusting the uplink transmission time offset to be larger than a timing advance value for the scheduled uplink transmissions; and
instructing the terminal device to apply the adjusted uplink transmission time offset.

19. A method performed by a terminal device, comprising:
determining whether to transmit a message indicating an uplink transmission failure based on a condition relating to at least an uplink transmission time offset for scheduled uplink transmissions and a timing advance value for the scheduled uplink transmissions; and
transmitting to a network device, the message, in a case where the condition is satisfied.

20. The method of claim 19, wherein the uplink transmission time offset is configured by the network device and is between receiving a downlink transmission and performing a corresponding uplink transmission, and the timing advance value is calculated by the terminal device.

21. The method of claim 19, wherein the condition is satisfied in a case where the uplink transmission time offset is less than the timing advance value; or in a case where the uplink transmission time offset is less than the timing advance value plus a duration for processing a downlink transmission and preparing a corresponding uplink transmission.

22-40. (canceled)
